(19) United States
(12) Patent Application Publication
(10) Pub. No.: US 2006/0217015 A1
(43) Pub. Date: Sep. 28, 2006

(54) Bamboo slat

(76) Inventor: Chin-Yu Chen, Changhua Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/086,699

(22) Filed: Mar. 22, 2005

(51) Int. Cl. A41G 1/00; B32B 5/26

(52) U.S. Cl. 442/36; 428/22; 428/27; 428/292.4; 442/57

(57) ABSTRACT

A bamboo slat includes two overlapping plates, and a cloth sandwiched between the two overlapping plates. Each of the plates is made of a plurality of overlapping bamboo sheets interweaving each other in a staggered manner. Thus, each of the plates is made of a plurality of overlapping bamboo sheets interweaving each other in a staggered manner, so that each of the plates has a strengthened structure without bending.

### BACKGROUND OF THE INVENTION

1. Field of the Invention

The present invention relates to a bamboo slat, and more particularly to a bamboo slat for a window covering, such as a Venetian blind, vertical blind, curtain, or the like.

2. Description of the Related Art

A conventional Venetian blind 1 in accordance with the prior art shown in FIG. 8 comprises a plurality of slats “A”. A conventional vertical blind 2 in accordance with the prior art shown in FIG. 9 comprises a plurality of slats “A”. A conventional movable curtain 3 in accordance with the prior art shown in FIG. 10 comprises a plurality of slats “A”. However, each of the slats “A” is usually made of fiber cloth, plastic cloth or aluminum plate, thereby easily causing an environmental pollution.

### SUMMARY OF THE INVENTION

In accordance with one embodiment of the present invention, there is provided a bamboo slat, comprising a single plate made of a plurality of overlapping bamboo sheets interweaving each other in a staggered manner.

In accordance with another embodiment of the present invention, there is provided a bamboo slat, comprising two overlapping plates each made of a plurality of overlapping bamboo sheets.

In accordance with another embodiment of the present invention, there is provided a bamboo slat, comprising a cloth, and multiple pairs of overlapping plates bonded on two sides of the cloth, wherein each of the plates is made of a plurality of overlapping bamboo sheets.

The primary objective of the present invention is to provide a bamboo slat for a window covering, such as a Venetian blind, vertical blind, curtain, or the like.

Another objective of the present invention is to provide a bamboo slat, wherein each of the plates is made of a plurality of overlapping bamboo sheets interweaving each other in a staggered manner, so that each of the plates has a strengthened structure without bending.

A further objective of the present invention is to provide a bamboo slat, wherein each of the plates is made of a plurality of bamboo sheets and is cut according to the required size of the bamboo slat without being limited by the size of the bamboo material, so that the bamboo slat is cut to have a determined size to fit a covering, thereby saving the material of fabrication.

A further objective of the present invention is to provide a bamboo slat, wherein the bamboo slat is made of the bamboo material, thereby achieving an environment protection purpose.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a bamboo slat in accordance with the preferred embodiment of the present invention;

FIG. 2 is an exploded perspective view of the bamboo slat as shown in FIG. 1;

FIG. 3 is a partially cut-away perspective view of the bamboo slat for a Venetian blind in accordance with the preferred embodiment of the present invention;

FIG. 4 is a perspective view of a bamboo slat in accordance with another preferred embodiment of the present invention;

FIG. 5 is a partially cut-away perspective view of the bamboo slat for a curtain in accordance with another preferred embodiment of the present invention;

FIG. 6 is a perspective view of a bamboo slat in accordance with another preferred embodiment of the present invention;

FIG. 7 is a perspective view of a bamboo slat in accordance with another preferred embodiment of the present invention;

FIG. 8 is a perspective view of a conventional Venetian blind in accordance with the prior art;

FIG. 9 is a perspective view of a conventional vertical blind in accordance with the prior art; and

FIG. 10 is a perspective view of a conventional curtain in accordance with the prior art.

### DETAILED DESCRIPTION OF THE INVENTION

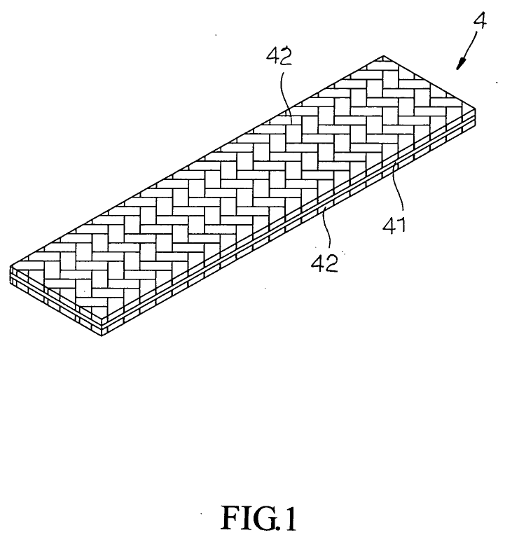

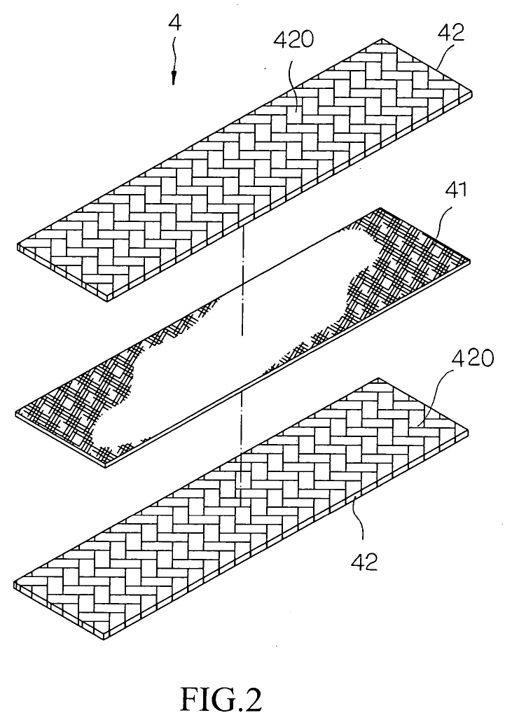

Referring to the drawings and initially to FIGS. 1 and 2, a bamboo slat 4 in accordance with the preferred embodiment of the present invention comprises two overlapping plates 42, and a cloth 41 sandwiched between the two overlapping plates 42.

Each of the plates 42 is made of a plurality of overlapping bamboo sheets 420 interweaving each other in a staggered manner. Each of the plates 42 is bonded on a side of the cloth 41 respectively by a bonding agent, such as a food-use adhesive. The plates 42 are bonded on the cloth 41 in a symmetric manner.

In fabrication, the bamboo sheets 420 are pressed a press closely to form each of the plates 42. Then, each of the plates 42 is bonded on the cloth 41 respectively by the bonding agent. Then, the plates 42 and the cloth 41 are pressed the press closely to form the bamboo slat 4 as shown in FIG. 1. In such a manner, the bamboo slat 4 is cut to have a determined size to fit a covering.

Accordingly, each of the plates 42 is made of a plurality of overlapping bamboo sheets 420 interweaving each other in a staggered manner, so that each of the plates 42 has a strengthened structure without bending. In addition, each of the plates 42 is made of a plurality of bamboo sheets 420 and is cut according to the required size of the bamboo slat 4 without being limited by the size of the bamboo material, so that the bamboo slat 4 is cut to have a determined size to fit a covering, thereby saving the material of fabrication. Further, the bamboo slat 4 is made of the bamboo material, thereby achieving an environment protection purpose.

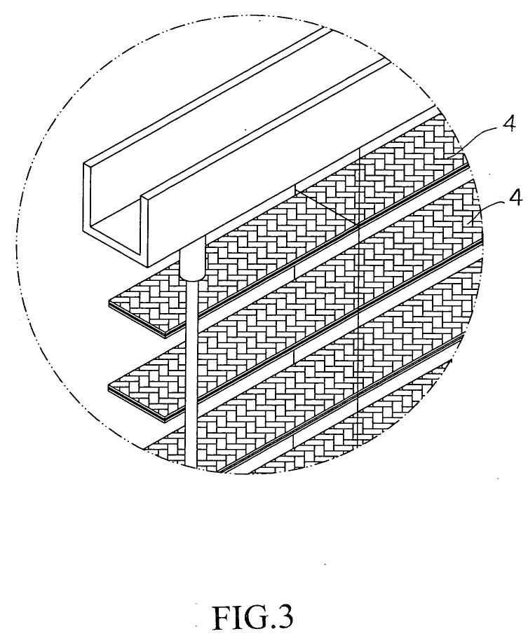

As shown in FIG. 3, the bamboo slat 4 is used for a Venetian blind which includes a plurality of bamboo slats 4.

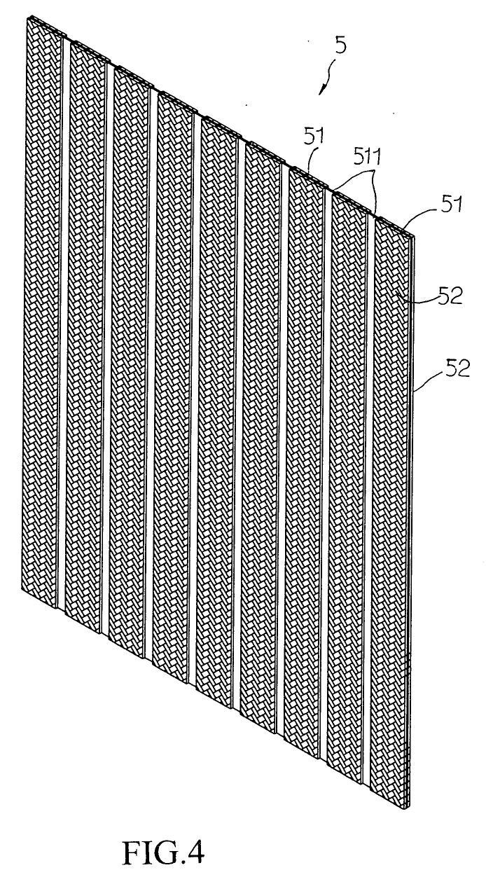

Referring to FIG. 4, a bamboo slat 5 in accordance with another preferred embodiment of the present invention comprises a cloth 51, and multiple pairs of overlapping plates 52 bonded on two sides of the cloth 51. The plates 52 are bonded on the cloth 41 in a symmetric manner. The cloth 51 has a plurality of bending gaps 511 located between the overlapping plates 52, so that the overlapping plates 52 are bendable.

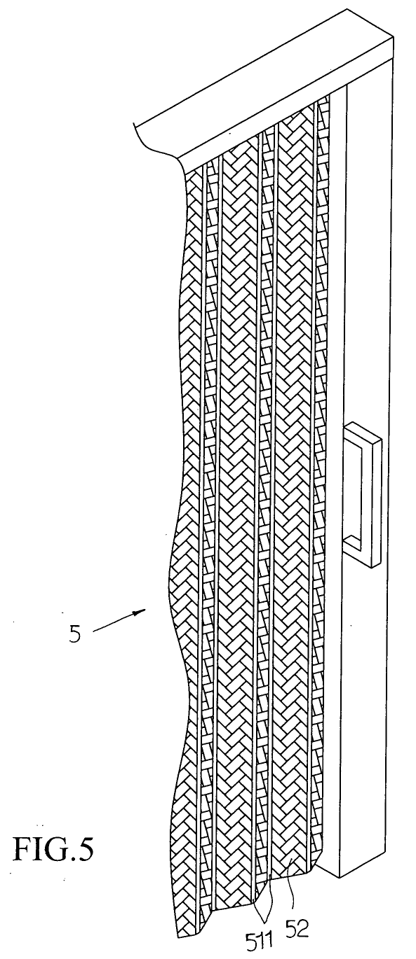

As shown in FIG. 5, the bamboo slat 5 is used for a movable curtain.

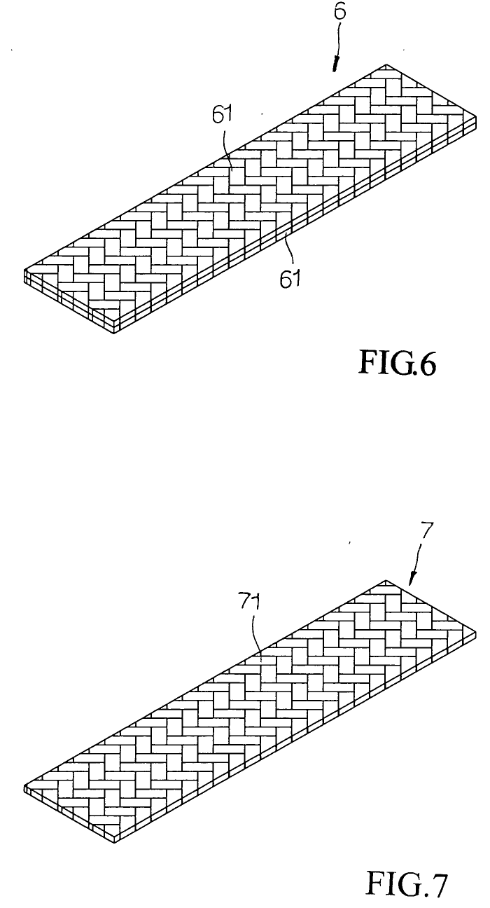

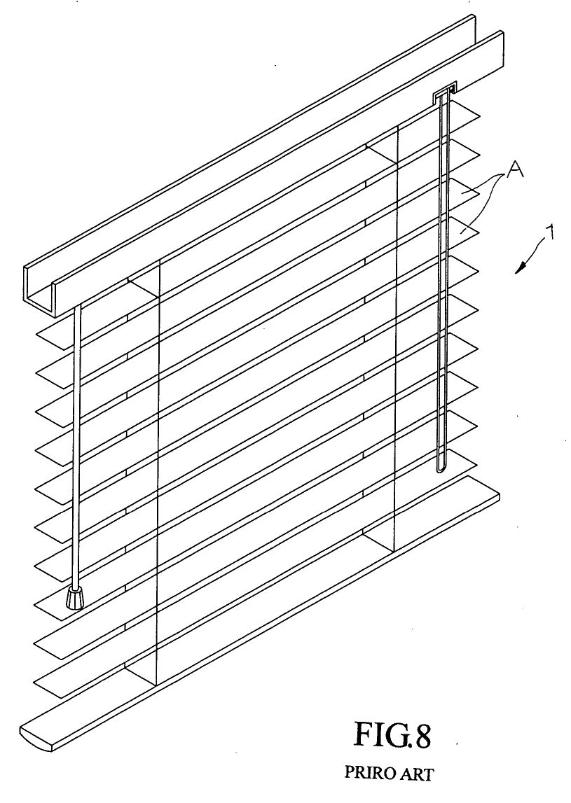

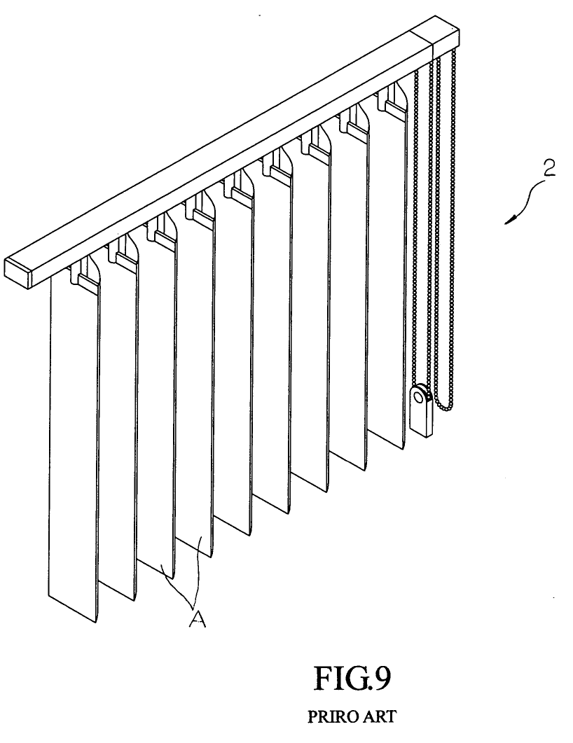

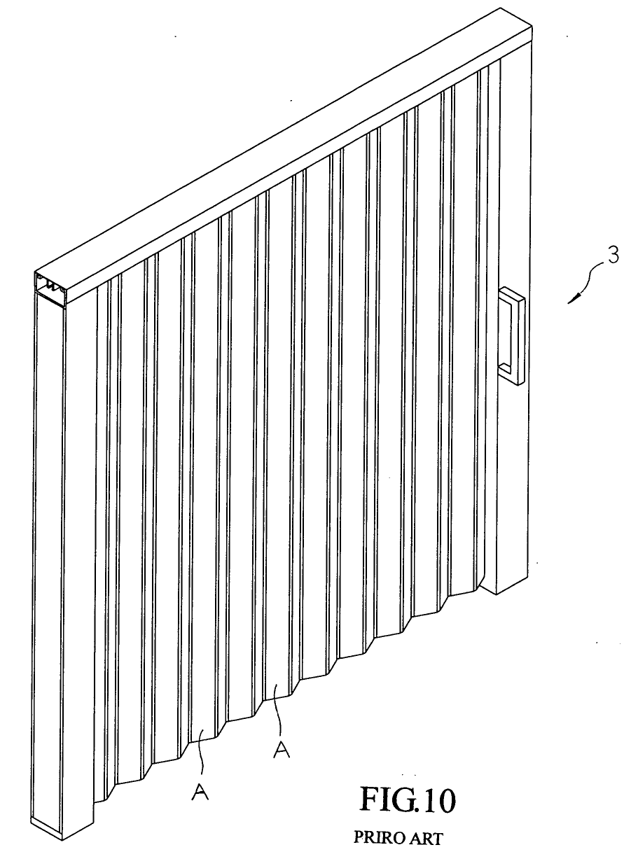

Referring to FIG. 6, a bamboo slat 6 in accordance with another preferred embodiment of the present invention comprises two overlapping plates 61.

Referring to FIG. 7, a bamboo slat 7 in accordance with another preferred embodiment of the present invention comprises a single plate 71.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A bamboo slat, comprising:
a single plate made of a plurality of overlapping bamboo sheets interweaving each other in a staggered manner.

2. A bamboo slat, comprising:
two overlapping plates each made of a plurality of overlapping bamboo sheets.

3. The bamboo slat in accordance with claim 2, wherein the overlapping bamboo sheets interweave each other.

4. The bamboo slat in accordance with claim 3, wherein the overlapping bamboo sheets interweave each other in a staggered manner.

5. The bamboo slat in accordance with claim 1, further comprising a cloth sandwiched between the two overlapping plates.

6. The bamboo slat in accordance with claim 5, wherein each of the plates is bonded on a side of the cloth respectively by a bonding agent.

7. The bamboo slat in accordance with claim 6, wherein the bonding agent is a food-use adhesive.

8. The bamboo slat in accordance with claim 6, wherein the plates are bonded on the cloth in a symmetric manner.

9. A bamboo slat, comprising:
a cloth;
multiple pairs of overlapping plates bonded on two sides of the cloth;
wherein each of the plates is made of a plurality of overlapping bamboo sheets.

10. The bamboo slat in accordance with claim 9, wherein the overlapping bamboo sheets interweave each other.

11. The bamboo slat in accordance with claim 10, wherein the overlapping bamboo sheets interweave each other in a staggered manner.

12. The bamboo slat in accordance with claim 9, wherein each of the plates is bonded on a side of the cloth respectively by a bonding agent.

13. The bamboo slat in accordance with claim 12, wherein the bonding agent is a food-use adhesive.

14. The bamboo slat in accordance with claim 9, wherein the plates are bonded on the cloth in a symmetric manner.

15. The bamboo slat in accordance with claim 9, wherein the cloth has a plurality of bending gaps located between the overlapping plates, so that the overlapping plates are bendable.
